(19) United States
(12) Patent Application Publication
(10) Pub. No.: US 2013/0067403 A1
(43) Pub. Date: Mar. 14, 2013

(54) ELECTRONIC DEVICE AND METHOD FOR DISPLAYING USER INTERFACE

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/489,604

(22) Filed: Jun. 6, 2012

(30) Foreign Application Priority Data
Sep. 14, 2011 (CN) 201110271658.2

(51) Int. Cl. G06F 3/048

(52) U.S. Cl. 715/809

(57) ABSTRACT

An electronic device includes a display unit, an input unit, and a processing unit. The display unit is used for displaying a menu in a user interface, the menu comprising a plurality of menu items. The input unit is used for selecting one of the menu items in response to user input and generating a first control signal. The processing unit responds to the first control signal to control the display unit to display a dialog box associated with the selected menu item in the user interface, wherein the actual position of the dialog box corresponds to the position of the selected menu item.

### BACKGROUND

1. Technical Field

The disclosed embodiments relate to an electronic device and a method for displaying a user interface.

2. Description of Related Art

Electronic devices, such as computers, may include a display unit. The display unit displays a user interface including a plurality of operation items, for example, folders, files, and applications. When the user need to operate (for example delete) one of the operation items (for example folders), firstly, the user must operate a mouse to move a pointer to be located over one of the folders and then perform a right click operation on the folder; then a delete menu item is displayed in a menu in the user interface, the menu being displayed is adjacent to the selected folder. Secondly, the user operates a mouse to move the pointer to be located over the delete menu item and performs a left click operation on the delete menu item, then a dialog box including an “ok” option and a “cancel” option is displayed in the user interface. Finally, the user operates the mouse to move the pointer to be located over the “ok” option and performs a selection operation on the “ok” option, then the selected folder is deleted successfully.

However, the plurality of operation items including folders, applications, and files are usually located in the left portion of the display unit, that is, the menu corresponding to the selected operation item and including a delete menu item is also located in the left portion of the display unit. The dialog box including the “ok” option and the “cancel” option is usually located in the middle portion of the display unit. Therefore, in order to delete one of the folders, the user need to operate the mouse to move the pointer from the left portion of the display unit to the middle portion of the display unit, it is inconvenient for the user.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the five views.

FIG. 1 is a block diagram of an electronic device in accordance with an embodiment.

FIG. 2 is a schematic diagram showing a user interface in accordance with a first embodiment.

FIG. 3 is a schematic diagram showing a user interface in accordance with a second embodiment.

FIG. 4 is a flow chart illustrating a method for displaying a user interface in accordance with an embodiment.

FIG. 5 is a flow chart illustrating a detailed method for displaying a dialog box in accordance with an embodiment.

### DETAILED DESCRIPTION

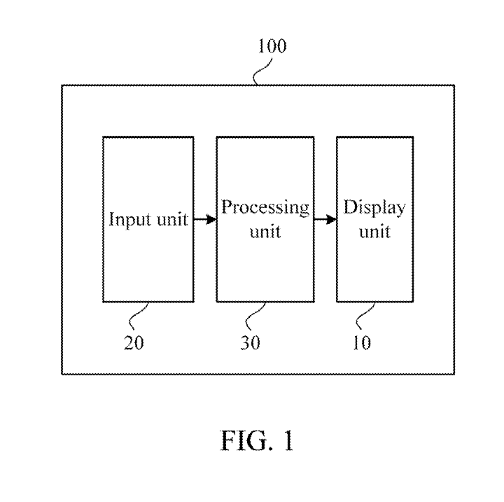

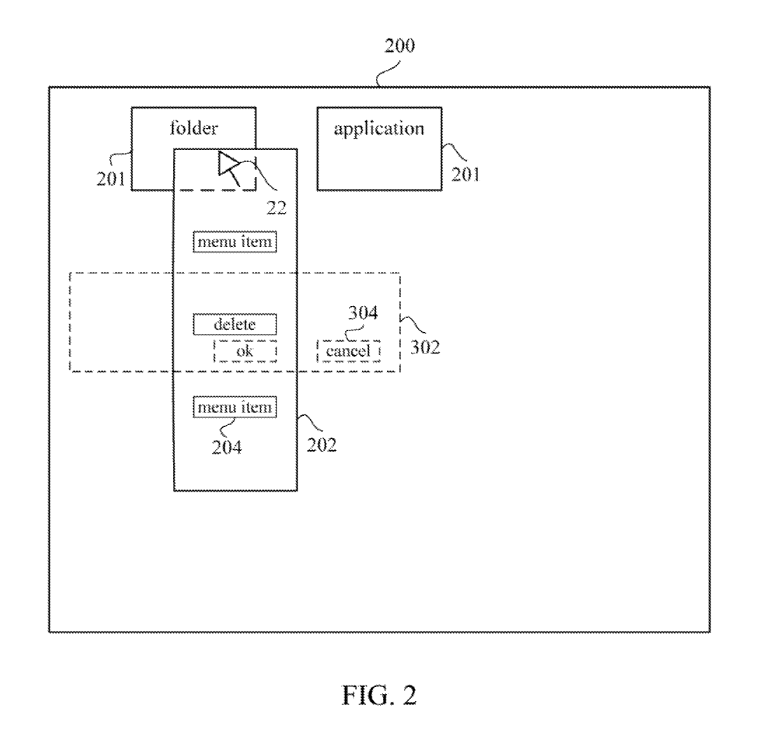

Referring to FIGS. 1 and 2, an electronic device 100 includes a display unit 10, an input unit 20, and a processing unit 30. The display unit 10 is used for displaying a plurality of operation items 201 in a user interface 200. In this embodiment, the operation items 201 are folders, applications, files, and the like; the electronic device 100 is a computer.

The input unit 20 causes a pointer 22 to be located over one of the operation items 201 and to perform a right click operation on one of the operation items 201 in response to user input, and generates a first control signal. The input unit 20 can be a mouse. In other embodiments, the input unit 20 causes the pointer 22 to perform a left click operation on one of the operation items 201 in response to user input and generates the first control signal.

The processing unit 30 responds to the first control signal to control the display unit 10 to display the menu 202 corresponding to the selected operation item 201 in the user interface 200. The menu 202 includes a plurality of menu items 204.

The input unit 20 further causes the pointer 22 to be located over one of the menu items 204 and to perform a left click operation on one of the menu items 204 in response to the user input, and generates a second control signal. In other embodiments, the input unit 20 causes the pointer 22 to perform a right click operation on one of the operation items 201 in response to user input and generates the second control signal.

The processing unit 30 responds to the second control signal to detect a coordinate of the selected menu item 204, and controls the display unit 10 to display a dialog box 302 associated with the selected menu item in the user interface 200 according to the detected coordinate. The dialog box 302 includes a plurality of options 304. In this embodiment, the selected menu item is a delete menu item, and the dialog box 302 includes an “ok” option and a “cancel” option; therefore, when the input unit 20 causes the pointer 22 to be located over on the “ok” option and to perform a left click operation on the “ok” option, the selected operation items 201 is deleted successfully.

In detail, the processing unit 30 further detects a total number of the options 304 and compares the detected total number with a predetermined number. If the detected total number is less than or equal to the predetermined number, the processing unit 30 controls the display unit 10 to display the dialog box 302 in a predetermined area, the coordinate of a center of the predetermined area is the same as the detected coordinate.

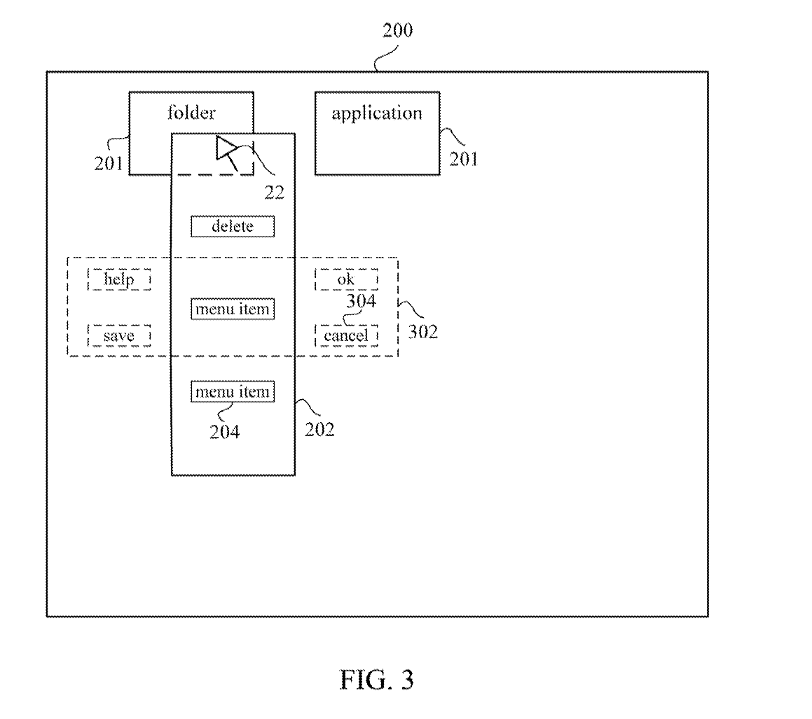

Referring to FIG. 3, if the detected total number is more than the predetermined number, the processing unit 30 calculates the coordinate of the center of the options 304 and locates the coordinate of the center of the options 304 in the predetermined area. In this embodiment, the predetermined number is 2, the predetermined area is an area of a rectangular box, the coordinate of the center of the rectangular box is the same as the detected coordinate. In other embodiment, the predetermined area can be an area of circle (not shown), and the coordinate of the center of the circle is the same as the detected coordinate.

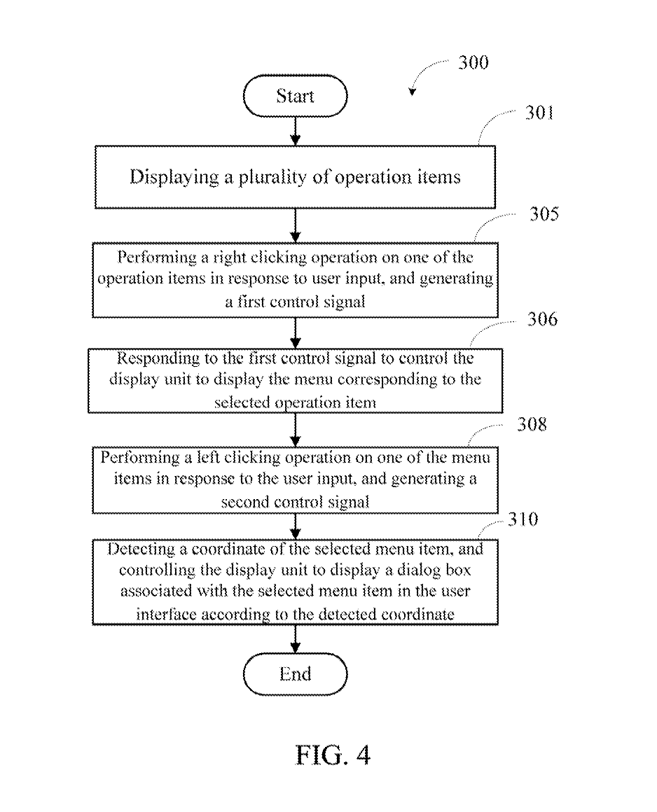

Referring to FIG. 4, a method 300 for displaying a user interface is illustrated, the method 300 is applied to the electronic device 100. The method 300 includes the following steps:

Step 301: the display unit 10 displays a plurality of operation items 201 in a user interface 200.

Step 305: the input unit 20 causes a pointer 22 to be located over one of the operation items 201 and to perform a right click operation on one of the operation items 201 in response to user input, and generates a first control signal.

Step 306: the processing unit 30 responds to the first control signal to control the display unit 10 to display the menu 202 corresponding to the selected operation item 201 in the user interface 200. The menu 202 includes a plurality of menu items 204.

Step 308: the input unit 20 causes the pointer 22 to be located over one of the menu items 204 and to perform a left click operation on one of the menu items 204 in response to the user input, and generates a second control signal.

Step 310: the processing unit 30 responds to the second control signal to detect a coordinate of the selected menu item 204, and control the display unit 10 to display a dialog box 302 associated with the selected menu item in the user interface 200 according to the detected coordinate.

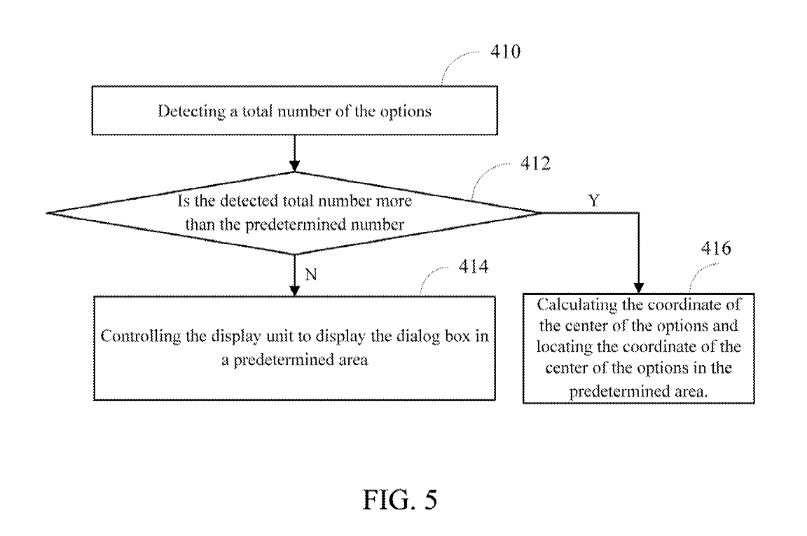

Referring to FIG. 5, step 310 is explained in detail, the step 310 further includes the following sub-steps:

Step 410: the processing unit 30 further detects a total number of the options 304.

Step 412: the processing unit 30 judges whether the detected total number is more than a predetermined number. If the detected total number is less than or equal to the predetermined number, the procedure goes to step 414. If the detected total number is more than the predetermined number, the procedure goes to step 416.

Step 414: the processing unit 30 controls the display unit 10 to display the dialog box 302 in a predetermined area, the coordinate of a center of the predetermined area is the same as the detected coordinate.

Step 416: the processing unit 30 calculates the coordinate of the center of the options 304 and aligns the coordinate of the center of the options 304 in the predetermined area. In this embodiment, the predetermined number is 2, the predetermined area is an area of a rectangular box, and the coordinate of the center of the rectangular box is the same as the detected coordinate. In other embodiments, the predetermined area is an area of a circle (not shown), and the coordinate of the center of the circle is the same as the detected coordinate.

Since the position of the dialog box 302 corresponds to the position of the selected menu item 204, in order to delete one of the folders, the user merely operate the mouse to move the pointer 22 from the selected menu item 204 to the “ok” option of the dialog box 302, as compared to the prior art requiring that the pointer 22 controlled by the mouse needs to be moved from the left portion of the display unit 10 to the middle portion of the display unit 10, the movement distance of the pointer 22 is effectively reduced, for the convenience and working speed of the user.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. An electronic device, comprising:
a display unit for displaying a menu in a user interface, the menu comprising a plurality of menu items;
an input unit for selecting one of the menu items in response to user input and generating a first control signal; and
a processing unit for responding to the first control signal to detect a coordinate of the selected menu item, and control the display unit to display a dialog box associated with the selected menu item in the user interface according to the detected coordinate.

2. The electronic device of claim 1, wherein the dialog box comprises a plurality of options, the processing unit further detects a total number of the options and compares the detected total number with a predetermined number, when the detected total number is less than or equal to the predetermined number, the processing unit controls the display unit to display the dialog box in a predetermined area, the coordinate of a center of the predetermined area is the same as the detected coordinate.

3. The electronic device of claim 2, wherein when the detected total number is more than the predetermined number, the processing unit calculates the coordinate of the center of the plurality of options and locates the coordinate of the center of the plurality of options in the predetermined area.

4. The electronic device of claim 3, wherein the predetermined area is an area of a rectangular box, the coordinate of the center of the rectangular box is the same as the detected coordinate.

5. The electronic device of claim 3, wherein the predetermined area is an area of a circle, the coordinate of the center of the circle is the same as the detected coordinate.

6. The electronic device of claim 3, wherein the predetermined number is 2.

7. The electronic device of claim 1, wherein the selected menu item is a delete menu item.

8. The electronic device of claim 2, wherein the dialog box comprises an “ok” option and a “cancel” option.

9. The electronic device of claim 1, wherein the display unit is further used for displaying a plurality of operation items in the user interface, the input unit is further used for causing a pointer to be located over one of the operation items and to perform a click operation on one of the operation items in response to user input, and generating a second control signal; the processing unit is used for responding to the second control signal to control the display unit to display the menu corresponding to the selected operation item in the user interface.

10. The electronic device of claim 1, wherein the plurality of operation items comprise applications, files and folders.

11. A method for displaying a user interface, the method comprising the steps of:
displaying a menu in the user interface via a display unit, the menu comprising a plurality of menu items;
selecting one of the menu items in response to user input and generating a first control signal; and
responding to the first control signal to detect a coordinate of the selected menu item, and control the display unit to display a dialog box associated with the selected menu item in the user interface according to the detected coordinate.

12. The method of claim 11, wherein the dialog box comprises a plurality of options, the step of displaying the dialog box comprises the sub-steps of:
detecting a total number of the options and comparing the detected total number with a predetermined number; and
controlling the display unit to display the dialog box in a predetermined area when the detected total number is less than or equal to the predetermined number;
wherein the coordinate of a center of the predetermined area is the same as the detected coordinate.

13. The method of claim 12, wherein the step of displaying the dialog box further comprises the sub-steps of:
calculating the coordinate of the center of the plurality of options and locating the coordinate of the center of the plurality of options in the predetermined area when the detected total number is more than the predetermined number.

14. The method of claim 13, wherein the predetermined area is an area of a rectangular box, the coordinate of the center of the rectangular box is the same as the detected coordinate.

15. The method of claim 13, wherein the predetermined area is an area of a circle, the coordinate of the center of the circle is the same as the detected coordinate.

16. The method of claim 13, wherein the predetermined number is 2.

17. The method of claim 11, wherein the selected menu item is a delete menu item.

18. The method of claim 11, wherein the step of displaying a menu in a user interface further comprises:
displaying a plurality of operation items in the user interface;
selecting one of the operation items in response to user input and generating a second control signal; and
responding to the second control signal to control the display unit to display the menu corresponding to the selected operation item in the user interface.

19. An electronic device, comprising:
a display unit for displaying a menu in a user interface, the menu comprising a plurality of menu items;
an input unit for selecting one of the menu items in response to user input and generating a first control signal; and
a processing unit for responding to the first control signal to control the display unit to display a dialog box associated with the selected menu item in the user interface,
wherein the position of the dialog box corresponds to the position of the selected menu item.
